(19) United States
(12) Patent Application Publication
(10) Pub. No.: US 2021/0331853 A1
(43) Pub. Date: Oct. 28, 2021

(54) DEVICE FOR STORING AND DISCHARGING LIQUID

(71) Applicant: INNERBOTTLE CO.,LTD., Seongnam-si, Gyeonggi-do (KR)

(72) Inventor: Sea Il OH, Suwon-si, Gyeonggi-do (KR)

(73) Assignee: INNERBOTTLE CO.,LTD., Seongnam-si, Gyeonggi-do (KR)

(21) Appl. No.: 16/478,120

(22) PCT Filed: Oct. 31, 2018
(86) PCT No.: PCT/KR2018/013070

§ 371 Date: Jul. 15, 2019

(51) Int. Cl. B65D 77/06; A45D 34/00; B05B 11/00

(52) U.S. Cl. CPC B65D 77/06; A45D 2200/05; B05B 11/0038; A45D 34/00

(57) ABSTRACT

Disclosed is a content discharging device according to an embodiment of the present disclosure. The content discharging device includes a flexible pouch having an opening at one side thereof, a fixing ring coupled to the opening, and a discharging portion coupled to the fixing ring and capable of conveying content. The flexible pouch is inserted into a rigid container with a shape, and the discharging portion is coupled to the opening of the rigid container. The content discharging device according to the present disclosure provides the effect of allowing consumption of content completely without remainder even when the liquid with high viscosity is filled in the rigid container, and the effects, in which the pouch with the elasticity is deformed in conformity with a shape having the rigid container and the content can be contained therein when the content have been contained in the pouch in the case of providing the pouch with the elasticity capable of being inserted into the rigid container, and that can discharge the content into the outside of the container by a restoring force according to the elasticity.

### TECHNICAL FIELD

The present disclosure relates to a device for storing and discharging liquid, and more particularly, to a container device which allows storing and discharging liquid so that content therein may be consumed completely without leaving content therein.

### BACKGROUND ART

FIG. 1A is a view illustrating a device for storing liquid content with high viscosity according to the related art.

Liquid such as shampoo or lotion has relatively high viscosity. When stored in a container 10, the content with high viscosity 20 tends to stick to internal walls of the container due to the high viscosity of the content. Nevertheless, these products are generally sold in rigid containers 10 having openings smaller in diameter than the storage space as illustrated in FIG. 1A, because of esthetic reasons, user convenience, etc. That is, they are often sold while stored in a plastic container having a shape such as illustrated in FIG. 1A because of consumer sensitivity or user convenience, etc. As such, a method of discharging the content generally involves attaching a pump to a discharging portion 30 for user convenience, and sucking and discharging the content to a discharging tube 31 by a pumping operation through air pressure. While the discharging mechanism operates without problem when the container 100 has enough volume of content 20 so that the content can be discharged through the discharging tube 31, a problem may arise when an amount of the residual content is small in the container such that the residual content stick to the internal walls of the container and do not fall off therefrom. In such case, it is difficult to discharge the residual content, and may cause a great obstacle to completely consume the content such as shampoo or lotion.

FIG. 1B is a view illustrating a container having a small amount of residual content in the device for storing the liquid content with high viscosity according to the related art.

As illustrated in FIG. 1B, there is a problem that, at certain point, when the amount of the residual content 21 is small, the residual content 21 adhere to the internal walls of the container 10 and do not fall off from the container 10. In addition, the space where the discharging tube 31 can reach is limited, thereby causing inefficient discharge of the residual content 21 in the container. Such a problem makes it difficult to consume a large amount of content stuck to the internal walls of the container such that it is not properly discharged, thereby causing the following serious problems.

Firstly, the unused content which is out of reach may still remain in the rigid container, thereby causing unnecessary waste of resources.

Secondly, a discarded container may still contain lotion, shampoo, or detergent, which may cause environmental pollution.

Thirdly, when a discharger such as a pump is disassembled from the container to open a discharging port in order to consume the residual content in the container that is not discharged to the discharger, the content may be contaminated due to foreign substances, etc. introduced from outside.

Fourthly, it is difficult to precisely discharge a wanted amount of content when a user disassembles the discharger from the container and attempts to discharge by turning over and shaking the container.

Therefore, there is a need for introducing a container and a method capable of effectively injecting and discharging the content with high viscosity without compromising esthetic sense and convenience by using a rigid container.

### DISCLOSURE

### Technical Problem

The inventor of the present disclosure has recognized that it is difficult to discharge the residual content using a pump, etc. when the liquid content sticks to internal walls of a container due to high viscosity and the surface tension of the liquid content and the residual content is small in volume, in case the liquid, in particular, the liquid with high viscosity is stored in a rigid container with a narrow opening, which diminishes the utility of the container. Nonetheless, the inventor has well recognized the voice of the relevant industries that rigid containers should inevitably be used because rigid containers make products look luxurious, and it is necessary to attach the pump, etc. to the discharging portion for convenience in consumption, etc.

Therefore, the inventor of the present disclosure has devised a container and a device in which a flexible pouch with elasticity (an elastic flexible pouch which is expandable) is inserted into the rigid container. The rigid container stores the liquid content in the elastic flexible pouch. The new and innovative method allows the content stored therein to be conveniently and completely consumed even a rigid container is used.

In this regard, as described above, in order to easily discharge the content even when the elastic flexible pouch is provided in the rigid container and the residual content is small in volume, a process of filling the elastic flexible pouch with content is necessary.

FIGS. 2A and 2B are views illustrating a process of filling liquid into a rigid container in a typical manufacturing procedure of shampoo, lotion, etc.

As illustrated in FIG. 2A, rigid containers which store liquid to be sold are arranged in a line on a conveying apparatus 50 and conveyed to a filling equipment 51. The filling equipment can have one or a plurality of nozzles 60 depending on its design.

As illustrated in FIG. 2B, when a rigid container is positioned below one or multiple nozzles, the nozzle moves downwardly above the opening of each rigid container to fill the content therein through the nozzle 61. At this time, the time required for the nozzle to move to fill the content and the amount to be filled per unit time of the nozzle are directly related to the production efficiency of the product, and therefore, generally, the nozzle vertically moves only by a minimum distance depending on the designing method, or sprays the content at that position without moving so that the content can be precisely stored in the rigid container. Therefore, in most cases, the nozzle and the opening of the rigid container are spaced apart from each other in performing the filling operation in consideration of the production efficiency, etc.

Meanwhile, the inventor of the present disclosure has also recognized a problem that, when the content is filled into the elastic flexible pouch through the method described herein, an injection pressure of the content through the opening of the rigid container is not strong enough to overcome the elasticity of the elastic flexible pouch when the volume of the elastic flexible pouch before expansion is not as large as the volume of the rigid container due to the elasticity of the elastic flexible pouch, such that the elastic flexible pouch cannot be inflated to store the content by the volume of the rigid container.

Therefore, in a cost efficiency aspect, there is a need to develop a method of manufacturing a container device which can fill the elastic flexible pouch with the content in order to utilize a new method by way of the elastic flexible pouch even with the conventional filling equipment without modification.

Therefore, an object of the present disclosure is to provide a device, a container, and a method for manufacturing the same, which allows full consumption of the content without remainder even when the liquid with high viscosity is stored in the rigid container through the container device which is capable of storing and discharging the liquid according to the present disclosure.

Another object of the present disclosure is to provide a device, a container, and a method for manufacturing the same, which can provide an elastic flexible pouch that can be inserted into the rigid container, thereby effectively using the residual content by taking out the flexible pouch from the container when the residual content is small in volume, which can be deformed into the shape of the rigid container when the elastic flexible pouch is inflated due to the elasticity of the pouch, thereby storing the content therein regardless of the shape of the rigid container, and which can apply the pressure at which the elastic flexible pouch constantly pushes the content toward the opening due to the elasticity (the restoring force) of the elastic flexible pouch.

Still another object of the present disclosure is to provide a device, a container, and a method for manufacturing the same, which can provide the content that are free from artificial impurity dilution, etc. in which the discharging port is smaller in diameter than the content storage such that the content is not taken out therefrom when a certain amount or more content is stored in the elastic flexible pouch.

Yet another object of the present disclosure is to provide a device, a container, and a method for manufacturing the same, which allows injection of the content to the extent of the volume of the rigid container even while providing the elastic flexible pouch, because the content cannot be injected to the extent of the volume of the rigid container due to the elasticity of the elastic flexible pouch when the volume of the elastic flexible pouch which is not expanded is smaller than the rigid container, in the case that a filling nozzle uses a method for spraying or flowing the content above the opening of the rigid container as in the conventional method in the case of filling the content into the rigid container provided with the elastic flexible pouch.

The objects of the present disclosure are not limited to the above-mentioned objects, and other objects not described can be clearly understood by those skilled in the art from the following description.

### Technical Solution

A container device capable of storing and discharging liquid according to an embodiment of the present disclosure for achieving the above-described objects is provided. The container device includes: a rigid container having a rigid case and having an opening at one side thereof; a discharging portion coupled to the opening; an elastic flexible pouch having an injection port at one end, the injection port being coupled to the discharging portion; and an air discharging port formed at the rigid container. The elastic flexible pouch and the rigid container are coupled so that content flows only into the elastic flexible pouch when the elastic flexible pouch is inserted into the rigid container and the content flows into the opening, and the discharging portion connects the injection port and the opening to be sealed so that the air in a space between the rigid container and the elastic flexible pouch can flow into and out only through the air discharging port.

According to another feature of the present disclosure, the elastic flexible pouch is inflated to fit to a shape of the rigid container when the air in a space between the elastic flexible pouch and the rigid container is discharged through the air discharging port.

According to still another feature of the present disclosure, the discharging portion includes a container coupling portion coupled with the rigid container and an upper cap coupled with the discharger, and the container coupling portion is coupled with the elastic flexible pouch.

According to yet another feature of the present disclosure, the container coupling portion further includes an air blocking portion to prevent the air from flowing into and out between the container coupling portion and the rigid container when coupling with the rigid container.

According to still yet another feature of the present disclosure, the container coupling portion and the rigid container are coupled by the screw coupling.

According to further feature of the present disclosure, a unit discharging speed of the content contained in the elastic flexible pouch may be adjusted based on the size and/or the thickness of the elastic flexible pouch.

According to another further feature of the present disclosure, a unit discharging amount of the content contained in the elastic flexible pouch may be adjusted based on the size and/or the thickness of the elastic flexible pouch.

According to still another further feature of the present disclosure, the elastic flexible pouch allows consumption of the content in the elastic flexible pouch without remainder because the elastic flexible pouch shrinks and the bottom surface of the elastic flexible pouch contacts the discharger as the content contained therein are discharged.

A method for manufacturing a container device capable of storing and discharging liquid according to an embodiment of the present disclosure for achieving the above-described objects is provided. The method for manufacturing the container device includes: coupling an elastic flexible pouch to a discharging portion; coupling the elastic flexible pouch and a rigid container so that the content flows into the elastic flexible pouch when the discharging portion is coupled to an opening of the rigid container and the content flows into the opening; lowering a pressure of a residual space by discharging the air in the residual space, which is a space in the rigid container as an external space of the elastic flexible pouch through an air discharging port; and sealing the air discharging port after the air of the residual space is sufficiently removed and the elastic flexible pouch is inflated in the rigid container.

According to another feature of the present disclosure, the method for manufacturing the container device capable of storing and discharging liquid further includes injecting liquid through the opening of the discharging portion and coupling a discharger to the discharging portion.

A method for manufacturing a container device capable of storing and discharging liquid according to an embodiment of the present disclosure for achieving the above-described objects is provided. The method for manufacturing the container device includes: coupling an elastic flexible pouch and a rigid container so that the content flows into the elastic flexible pouch when the content flows into the opening of the rigid container; lowering a pressure of a residual space by discharging the air in the residual space that is a space in the rigid container as an external space of the elastic flexible pouch through an air discharging port; and sealing the air discharging port after the air of the residual space is sufficiently removed and the elastic flexible pouch is inflated in the rigid container.

According to another aspect of an embodiment of the present disclosure, a container device includes: a rigid container having a rigid exterior case and having an opening at one side thereof; a discharging portion coupled to the opening; and an injection port at one side thereof. The injection port includes an elastic flexible pouch coupled with the discharging portion and an air discharging port formed in the rigid container, the elastic flexible pouch and the rigid container are coupled so that content flows only into the elastic flexible pouch when the elastic flexible pouch is inserted into the rigid container and the content flows into the opening, and the discharging portion connects the injection port and the opening to be sealed so that the air in a space between the rigid container and the elastic flexible pouch can flow into and out only through the air discharging port.

According to another feature of the present disclosure, the elastic flexible pouch is inflated to fit to a shape of the rigid container when the air in the space between the elastic flexible pouch and the rigid container is discharged through the air discharging port.

According to still another feature of the present disclosure, the discharging portion includes a container coupling portion coupled to the rigid container and an upper cap coupled to the discharger, and the container coupling portion is coupled with the elastic flexible pouch.

According to yet another feature of the present disclosure, the container coupling portion further includes an air blocking portion to prevent the air from flowing into and out between the container coupling portion and the rigid container when coupling with the rigid container.

According to still yet another feature of the present disclosure, the container coupling portion and the rigid container are coupled by the screw coupling.

According to further feature of the present disclosure, a unit discharging speed of the content contained in the elastic flexible pouch may be adjusted based on the size and/or the thickness of the elastic flexible pouch.

According to another further feature of the present disclosure, a unit discharging amount of the content contained in the elastic flexible pouch may be adjusted based on the size and/or the thickness of the elastic flexible pouch.

According to still another further feature of the present disclosure, the elastic flexible pouch allows consumption of the content in the elastic flexible pouch without remainder because elastic flexible pouch shrinks and the bottom surface of the elastic flexible pouch contacts the discharger as the content contained therein are discharged.

A method for manufacturing a container device according to still another aspect of an embodiment of the present disclosure includes: coupling an elastic flexible pouch and a discharging portion; coupling the elastic flexible pouch and a rigid container so that content flows into the elastic flexible pouch when the discharging portion is coupled to an opening of the rigid container and the content flows into the opening; lowering a pressure of a residual space by discharging the air in the residual space that is a space in the rigid container as an external space of the elastic flexible pouch through an air discharging port; and sealing the air discharging port after the air of the residual space is sufficiently removed and the elastic flexible pouch is inflated in the rigid container.

According to another feature of the present disclosure, the method for manufacturing the container device further includes injecting liquid through the opening of the discharging portion and coupling a discharger to the discharging portion.

A method for manufacturing a container device according to yet another aspect of an embodiment of the present disclosure includes: coupling an elastic flexible pouch and a rigid container so that content flows into the elastic flexible pouch when the content flows into an opening of the rigid container; lowering a pressure of a residual space by discharging the air in the residual space that is a space in the rigid container as an external space of the elastic flexible pouch through an air discharging port; and sealing the air discharging port after the air of the residual space is sufficiently removed and the elastic flexible pouch is inflated in the rigid container.

### Advantageous Effects

The present disclosure is intended to solve the above problems, and the container device according to the present disclosure allows consumption of the content completely without remainder even when the liquid with high viscosity is stored in the rigid container.

It is possible for the container device according to an embodiment of the present disclosure to provide the elastic flexible pouch that can be inserted into the rigid container, thereby effectively using the residual content by taking out the flexible pouch from the container when the residual content is small in volume, to be deformed into the shape of the rigid container when the elastic flexible pouch is inflated due to the elasticity of the pouch, thereby storing the content therein regardless of the shape of the rigid container, and to apply the pressure at which the elastic flexible pouch always pushes the content toward the opening due to the elasticity (the restoring force) of the elastic flexible pouch.

It is possible for the container device according to an embodiment of the present disclosure to provide the content that are free from an artificial impurity dilution, etc. because the discharging port of the discharging portion is smaller in diameter than the content storage and the content is not taken out when the content is stored in the elastic flexible pouch by a certain amount or more.

It is possible for the container device according to an embodiment of the present disclosure to inject the content by the volume of the rigid container even while providing the elastic flexible pouch even when the filling nozzle sprays or flows the content above the opening of the container device without a special pressure when filling the content into the container device provided with the elastic flexible pouch.

### DESCRIPTION OF DRAWINGS

FIG. 1A is a view illustrating a device for storing the liquid content with high viscosity according to the related art.

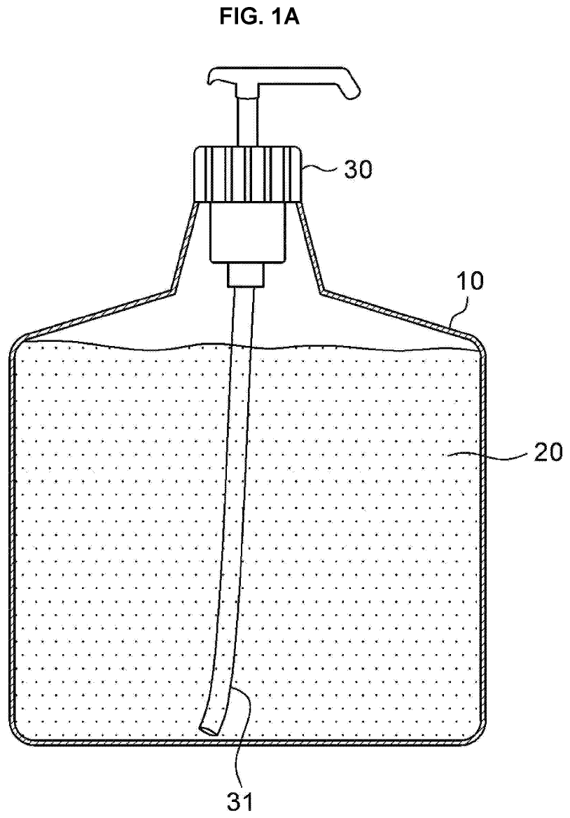

FIG. 1B is a view illustrating a container having a small amount of residual content in the device for storing the liquid content with high viscosity according to the related art.

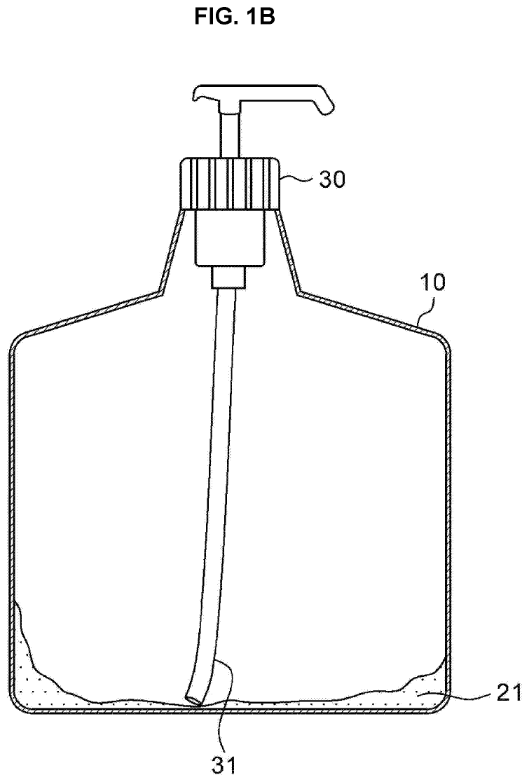

FIG. 2A is a view illustrating a process of filling liquid into a rigid container in a typical manufacturing process of shampoo, lotion, etc.

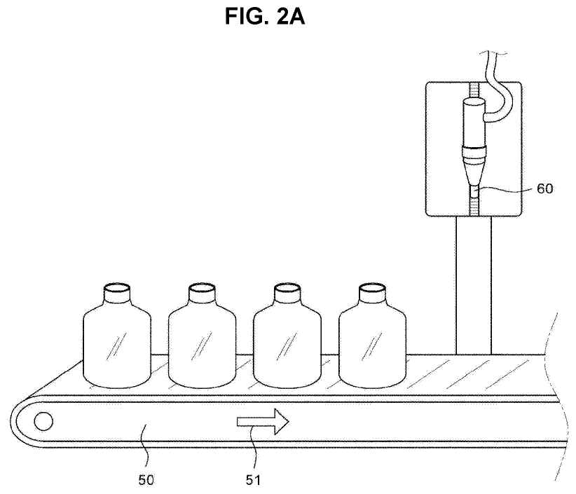

FIG. 2B is a view illustrating a process of filling the liquid into the rigid container in the typical manufacturing process of shampoo, lotion, etc.

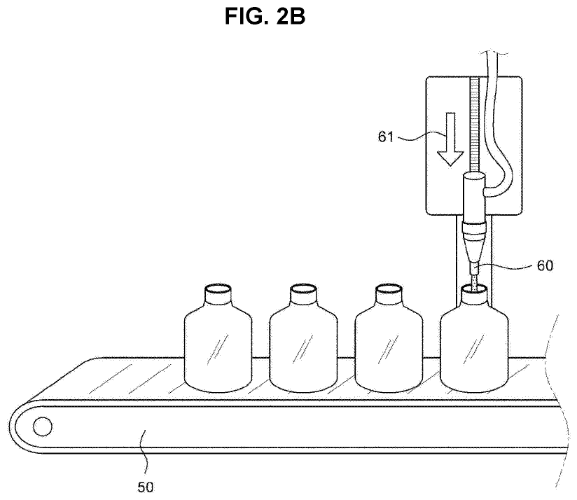

FIG. 3 is a view illustrating a content discharging device according to an embodiment of the present disclosure.

FIG. 4 is a view illustrating the content discharging device coupled to the container but the content is not filled yet according to an embodiment of the present disclosure.

FIG. 5 is a view illustrating the content discharging device coupled to the container and content is filled according to an embodiment of the present disclosure.

FIG. 6 is a view illustrating a discharging portion according to an embodiment of the present disclosure.

FIG. 7 is a view illustrating the discharging portion according to an embodiment of the present disclosure.

FIG. 8 is a view illustrating the content discharging device according to an embodiment of the present disclosure.

FIG. 9 is a view illustrating the content discharging device which is coupled to a container but content is not filled yet according to an embodiment of the present disclosure.

FIG. 10 is a view illustrating the container discharging device which is coupled to a container and content is filled according to an embodiment of the present disclosure.

FIG. 11 is a view illustrating a cross section of the discharging portion according to an embodiment of the present disclosure.

FIG. 12 is a view illustrating the discharging portion according to an embodiment of the present disclosure.

FIG. 13 is a view illustrating a container device according to an embodiment of the present disclosure.

FIG. 14 is a view illustrating a process of manufacturing the container device according to an embodiment of the present disclosure.

FIG. 15 is a view illustrating the fully assembled container device according to an embodiment of the present disclosure.

FIG. 16 is a view illustrating a state before the coupling of the discharging portion according to an embodiment of the present disclosure.

FIG. 17 is a view illustrating the discharging portion according to an embodiment of the present disclosure is coupled to an elastic flexible pouch.

FIG. 18 is a view illustrating a process of manufacturing the container device according to an embodiment of the present disclosure.

### BEST MODE

The advantages and features of the present disclosure and the method for achieving them will become apparent with reference to the embodiments, which will be described in detail below together to the accompanying drawings. However, the present disclosure is not limited to the embodiments disclosed below, but can be implemented in many different forms, and the embodiments are merely provided so that the disclosure of the present disclosure is thorough, and to fully convey the scope of the disclosure to those skilled in the art to which the present disclosure pertains, and the present disclosure is only defined by the scope of the claims.

Although ordinal numbers such as the first, second, etc. are used to describe various components, it is quite certain that these components are not limited by these terms. These terms are used only to distinguish one component from another. Therefore, it is quite certain that the first component described below can also be the second component within the technical spirit of the present disclosure.

Throughout the specification, same reference numerals refer to the same components.

The respective features of various embodiments of the present disclosure can be coupled or combined with each other partially or entirely, various interlocking and driving is technically possible as can be understood by those skilled in the art, and the respective embodiments can be performed independently with respect to each other and can also be performed together in association therewith.

Meanwhile, the potential effects that can be expected by the technical features of the present disclosure, which has not been specifically described in the specification of the present disclosure, are regarded as described in the present specification, and the present embodiment is provided to explain the present disclosure for those skilled in the art more completely, such that the content illustrated in the drawings can be exaggerated compared to the actual implementation figure of the disclosure, and the detailed description of the configuration, which is determined to unnecessarily obscure the subject matter of the present disclosure is omitted or briefly described.

In the present specification, the ‘liquid’ refers to a wide range of materials in a liquid phase rather than a solid or gaseous phase. That is, it means all phases that have a short intermolecular distance and low kinetic energy but are not stuck with each other as strongly as solid-phase molecules, and is used as the meaning that includes all liquids from dilute liquid such as water to the liquid with high viscosity such as gels.

In the present specification, the elastic flexible pouch means all shapes of pouches that can be bent or folded as a pouch capable of containing liquid to be inserted into the container through the opening of the rigid container. In addition, in the present specification, the elastic flexible pouch means a flexible pouch having a restoring force to return to its original shape when expanded or inflated because of its ductility and the elasticity.

In the present specification, the container and the rigid container mean all kinds of containers having rigid materials such as plastic, glass, and metal.

In the present specification, the discharging portion connects the discharger and the flexible pouch by coupling with the opening of the flexible pouch or the elastic flexible pouch to couple with the discharger, and performs a function of coupling the flexible pouch and the container so that the flexible pouch can be fixed in the container. The discharging portion can be directly coupled with the flexible pouch or also coupled with the fixing ring to which the flexible pouch is coupled according to an embodiment of the present disclosure.

In the present specification, the discharging device means a device having the elastic flexible pouch capable of containing the content while having the coupling means that can be coupled to the rigid container by coupling the discharging portion and the elastic flexible pouch.

In the present specification, the container device means a device having the elastic flexible pouch in the rigid container and for containing and discharging the content in the elastic flexible pouch in the rigid container when filling the content therein.

In the present specification, the discharger is coupled with the discharging portion and performs a function of discharging the liquid content stored in the flexible pouch. The discharger can be implemented as a pump type, or can also be implemented by providing a valve for adjusting the amount of content per unit time conveyed to the discharging tube or the discharging portion when the content is automatically pushed to the discharging port by the restoring force because the flexible pouch has the elasticity according to an embodiment of the present disclosure.

Hereinafter, various embodiments of the present disclosure will be described in detail with reference to the accompanying drawings.

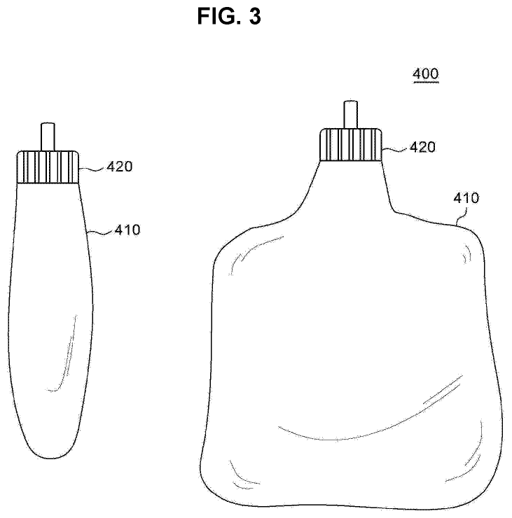

FIG. 3 is a view illustrating a content discharging device 400 according to an embodiment of the present disclosure. The content discharging device 400 according to the present disclosure may include a pouch 410 and a discharging portion 420.

The pouch 410 is made of a flexible material and one side thereof is opened and coupled with the discharging portion 420. The pouch 410 can be of a material of barrier resin such as polypropylene (PP), polyethylene (PE), polystyrene (PS), polyester (PET), Cellophane, NYLON, Poly Vinyl Chloride (PVC), Poly Vinylidene Chloride (PVDC), Citrene-acrylonitrile (SAN), bio-plastics, or EVOH, polysilicon, Oriented Poly Propylene (OPP), Low Density Polyethylene (LDPE), or Linear Low Density Polyethylene (LLDPE), and in addition, can also be made of any material as long as it is a packaging material capable of containing liquid as a flexible material. The discharging portion 420 is connected to one side opening of the pouch 410 to provide a passage through which the content is injected and discharged.

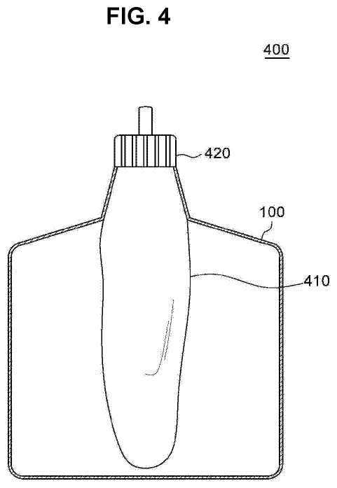

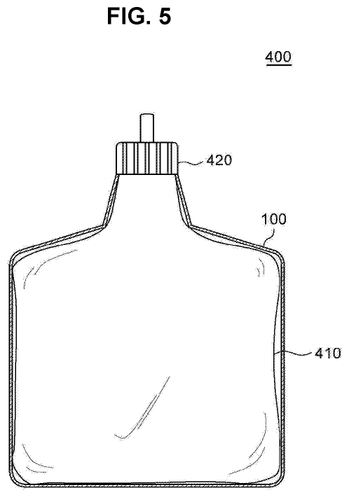

FIGS. 4 and 5 are views illustrating the content discharging device 400 coupled to the container 100 according to an embodiment of the present disclosure. Since the pouch 410 of the content discharging device 400 is made of a flexible material, it can be inserted into the container 100 even when the opening of the container 100 is small in diameter. At this time, the pouch 410 can be inserted into the container 100 while it is folded or rolled.

As illustrated in FIG. 5, when the content is injected into the pouch 410 of the content discharging device 400 through the discharging portion 420, the pouch 410 can be inflated to fit to a shape of the container 100. In this case, the pouch 410 is preferably manufactured in advance to fit to a shape of the container 100.

Hereinafter, each part constituting the content discharging device 400 will be described in detail.

[Pouch]

As described above, the pouch 410 can be made of a flexible material and expanded by an application of pressure according to the injection of the content, thereby increasing the volume to accommodate the content. The pouch 410 can be implemented with a shape that is integrally formed like a balloon by a method such as injection molding or as a pouch shape by press-laminating two flexible films. It is readily understood that the pouch 410 can also be made of any material as long as it is a material with the ductility as a material capable of containing the liquid.

[Discharging Portion]

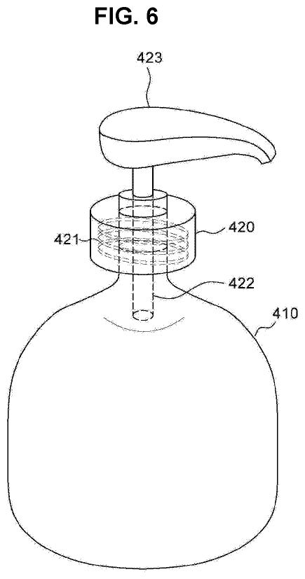

FIG. 6 is a view illustrating a discharging portion according to an embodiment of the present disclosure. The discharging portion 420 is connected with the pouch 410 to couple the content discharging device 400 with the container 100, and performs a function of injecting the liquid into the pouch 410 or discharging the liquid contained in the pouch 410. The discharging portion 420 may include a container coupling portion 421, a discharging tube 422, and a discharger 423.

The container coupling portion 421 is formed at the discharging portion 420 and performs a function of coupling the content discharging device 400 to the container. The container coupling portion 421 can also be configured as a part of the discharging portion 420, and can also be implemented as a separate structure from the discharging portion 420 according to the specific implementation of the disclosure.

The discharger 423 may be implemented as a part of the discharging portion 420, or, may be coupled to one side of the discharging portion 420 as a separate structure from the discharging portion 420. Therefore, the content discharging device 400 may be configured to have the discharging portion 420, which includes the discharger 423, as a part thereof, or, may also be configured to be equipped with only the discharging portion (lacking the discharger) and the pouch 410 so as to be implemented to utilize other generic type discharger coupled to one side thereof.

Meanwhile, the discharging tube 422 is a tube that performs a function of conveying the liquid in the pouch 410 to the discharger 423, and may be implemented integrally with the discharging portion 420, or coupled as a separate structure from the discharging portion 420. The discharging tube 422 may be implemented in various lengths depending on a configuration of the container 100 and a material of the pouch 410.

The discharger 423 performs a function of discharging the content conveyed through the discharging tube 422. Although it is illustrated in FIG. 6 that the discharger 423 adopts a pump-type method, it can be variously implemented in a pump type, a nozzle type, and a cap type according to a material of the pouch 410, the presence and absence of the restoring force of the pouch, the application of the product, etc.

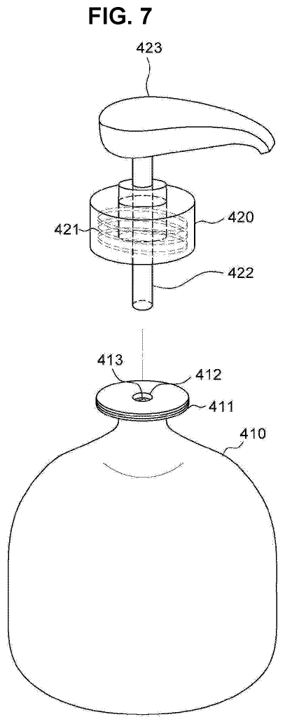

FIG. 7 is a view illustrating the discharging portion according to an embodiment of the present disclosure. According to the implementation method of the present disclosure, the discharging portion 420 may be designed to be separated from the pouch 410. In this case, the pouch 410 may further include a fixing ring 411 so that the pouch 410 may be coupled with the discharging portion 420. The fixing ring 411 may be designed to be physically separate from and coupled with the discharging portion 420. In such case, when the residual content is small in volume, the residual content in the pouch 410 can also be discharged by disassembling the discharging portion 420 from the fixing ring 411. In such case, the fixing ring 411 may include a discharging port 412 for inserting the discharger 423 into the pouch 410, and the discharging port 412 may further include a backflow prevention portion 413 for preventing the backflow of the content.

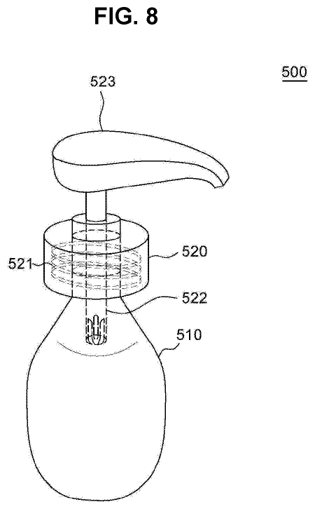

FIG. 8 is a view illustrating a content discharging device 500 according to an embodiment of the present disclosure. The content discharging device 500 according to the present disclosure may include an elastic pouch 510 and a discharging portion 520. The elastic pouch 510 may be made of a flexible elastic material, and has one side opened to be coupled with the discharging portion 520. The elastic pouch 510 may be made of a material of latex, silicone, or natural rubber. In addition, the elastic pouch 510 may also be made of any material as long as it is a packaging material capable of containing the liquid as a material with the elasticity.

The discharging portion 520 is connected to one side opening of the elastic pouch 510 to provide a passage through which the content is injected and discharged. A container coupling portion 521 is formed at the discharging portion 520 and performs a function of coupling the content discharging device 500 to the container. Although FIG. 8 illustrates that the container coupling portion 521 is integral with the discharging portion 520, the container coupling portion 521 may also be configured as a part of the discharging portion 520, and may also be implemented as a separate configuration from the discharging portion 520 depending on the implementation of the present disclosure. The discharging portion 520 may further provide a discharging tube 522, and the discharging tube 522 performs a function of conveying the content contained in the elastic pouch 510 to a discharger 523 connected to the discharging portion 520. At this time, the elastic pouch 510 can be increased in volume by the injection of the content and have a restoring force that pushes the content to the discharging portion 520 through the discharging tube 522. Therefore, the discharging portion 520 can provide a backflow prevention portion 524 that can prevent backflow when the content is once injected into the elastic pouch 510. The backflow prevention portion 524 may be formed at the discharging portion 520 and implemented in various forms in order to prevent unintended backflow of the content.

At this time, the backflow prevention portion 524 may include, for example, a valve made of an elastic material. A part of the discharging portion 520 can be inserted through the backflow prevention portion 524. The backflow prevention portion 524 can prevent the content from flowing back to the outside while the discharging portion 520 is not inserted into the backflow prevention portion 524, and the backflow prevention portion 524 can prevent the content from flowing back to the outside through the remaining part other than the discharging portion 520 while some parts of the discharging portion 520 are inserted therein.

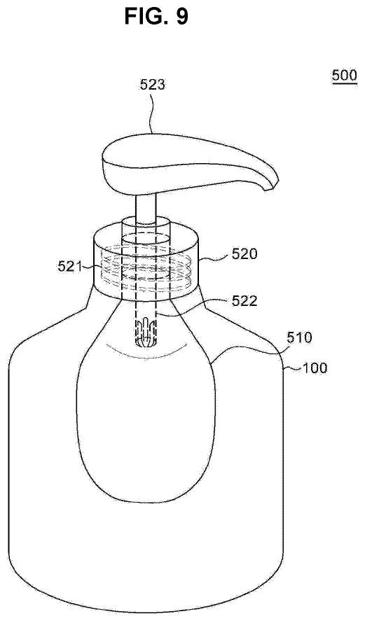

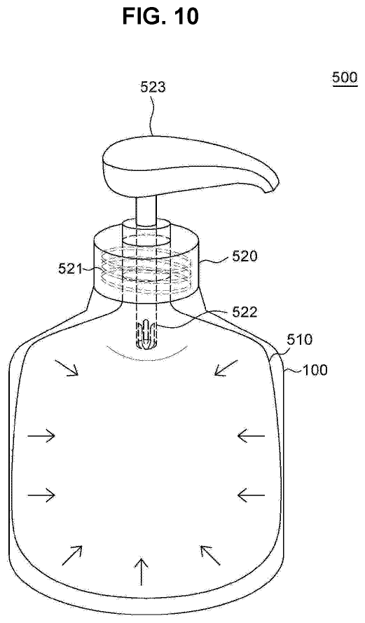

FIG. 9 is a view illustrating the content discharging device 500 which is coupled to a container but content is not filled yet according to an embodiment of the present disclosure. FIG. 10 is a view illustrating the content discharging device 500 according to an embodiment of the present disclosure coupled to the container which is filled with content. Since the elastic pouch 510 of the content discharging device 500 is made of a flexible elastic material, it can be inserted into the container 100 even when the opening of the container 100 is small in diameter. At this time, the elastic pouch 510 can be inserted into the container 100 as it is, and inserted into the container 100 while it is folded or rolled when the opening of the container 100 is not sufficiently large in diameter.

As illustrated in FIG. 10, the elastic pouch 510 can be expanded in conformity with a shape of the container 100 when the content is injected into the elastic pouch 510 of the content discharging device 500 through the discharging portion 520.

Hereinafter, each portion of the content discharging device 500 will be described in detail.

[Elastic Pouch]

As described above, the elastic pouch 510 may be made of a flexible material, and, when it is expanded by an application of pressure according to the injection of the content, the volume capable of containing the content increases, and the content reduces, the volume can be reduced by a restoring force for keeping its original shape again. The elastic pouch 510 may have a shape integrally formed like a balloon by a method such as the injection molding, and may also be implemented as any material as long as it is a material having the property of ductility and the restoring force such as silicone, latex, natural rubber, or synthetic rubber.

[Adjustment of a Content Discharging Speed Using a Restoring Force]

The elastic pouch 510 has a restoring force to restore back to the original state when the content is filled and the volume is expanded. Such a restoring force can operate as a driving force that can easily discharge the liquid in the elastic pouch 510 even without using a pump, etc. At this time, the speed of discharging and the amount of liquid to be discharged may be adjusted based on the size of the elastic pouch 510, the thickness of the elastic film constituting the pouch, and the shape of the elastic pouch 510.

[Discharging Portion]

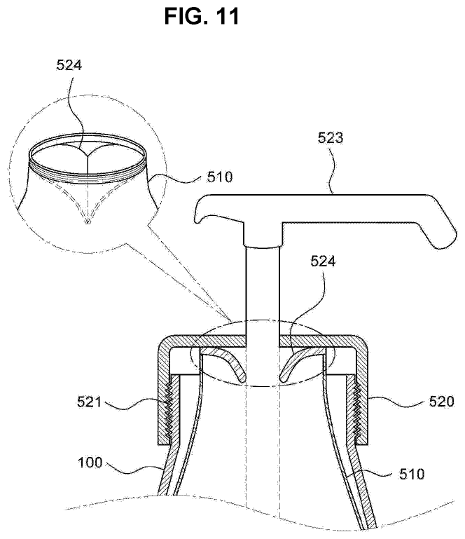

FIG. 11 is a view illustrating a cross section of the discharging portion according to an embodiment of the present disclosure. The discharging portion 520 is connected to the elastic pouch 510 to couple the content discharging device 500 to the container 100, and performs a function of injecting the liquid into the elastic pouch 510 or discharging the content contained in the elastic pouch 510. The discharging portion 520 may further include the container coupling portion 521, a discharging tube 522, the discharger 523, and a backflow prevention portion 524.

The container coupling portion 521 is formed at the discharging portion 520 and performs a function of coupling the content discharging device 500 to the container. Although FIG. 11 illustrates that the container coupling portion 521 is integral with the discharging portion 520, it may also be implemented separate from the discharging portion 520 depending on the implementation of the present disclosure.

The discharging tube 522 is a tube that performs a function of conveying the liquid in the elastic pouch 510 to the discharger 523, and may be implemented integrally with the discharging portion 520 or manufactured separately from the discharging portion 520 and coupled therewith. At this time, the discharging tube 522 may be implemented in various lengths depending on a shape of the container 100 and a material of the elastic pouch 510. Since the elastic pouch 510 has a restoring force, it has the property of pushing the content in the elastic pouch 510 to the discharger 523 through the discharging tube 522. Since the elastic pouch 510 has the property of reducing the volume to its original size as the amount of the content therein reduces, the size of the discharging tube 522 can be determined in consideration of the size of the elastic pouch 510 when it is reduced to its original size.

The discharger 523 performs a function of discharging the content conveyed through the discharging tube 522, and may be implemented in a pump type, a nozzle type, or a cap type depending on a material of the elastic pouch 510, etc.

Since the restoring force operates when the content such as liquid are contained in the elastic pouch 510, the backflow prevention portion 524 may be added thereto in order to prevent unintended discharge of the content. As illustrated in FIG. 11, the backflow prevention portion 524 may be implemented to have a valve structure, and in addition, may be implemented as various structures in order to prevent the backflow of the content.

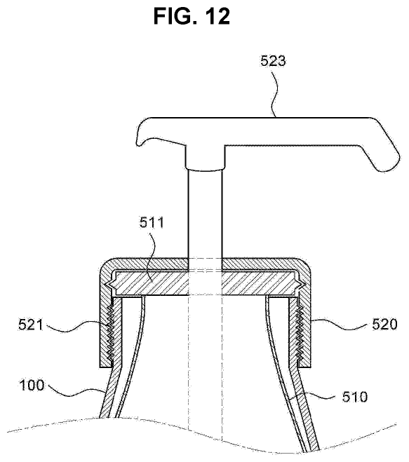

FIG. 12 is a view illustrating the discharging portion according to an embodiment of the present disclosure. The discharging portion 520 may be designed to be separate from the elastic pouch 510 according to the implementation method of the present disclosure. In this case, the elastic pouch 510 may further include a fixing ring 511 in order to couple the elastic pouch 510 with the discharging portion 520. The fixing ring 511 can be designed to be physically separate from and coupled with the discharging portion 520. In this case, when the residual content is small in volume, the residual content in the elastic pouch 510 can also be discharged by separating the discharging portion 520 from the fixing ring 511.

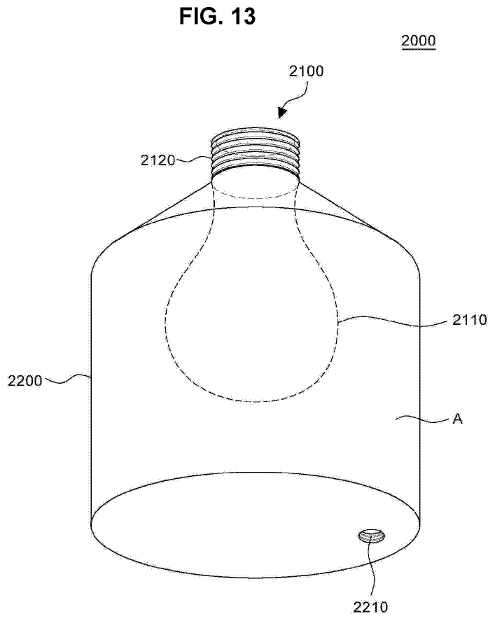

FIG. 13 is a view illustrating a container device 2000 according to an embodiment of the present disclosure. The container device 2000 according to the present disclosure may include a content discharging device 2100, an elastic flexible pouch 2110, a discharging portion 2120, a rigid container 2200, and an air discharging port 2210.

The elastic flexible pouch 2110 is made of a flexible material having elasticity, and has one side opened to be coupled with the discharging portion 2120. The elastic flexible pouch 2110 can be, for example, made of a material such as latex, silicone, silicon carbonate, or natural rubber, and in addition, can also be made of any material as long as it is a packaging material capable of containing the liquid as a material with the elasticity. The discharging portion 2120 is connected to one side opening of the elastic flexible pouch 2110 to provide a passage through which the content is injected and discharged.

The air discharging port 2210 is provided to discharge the air in space A between the rigid container 2200 and the content discharging device 2100 when the content discharging device 2100 is coupled to the rigid container 2200 and the elastic flexible pouch 2110 is inserted into the rigid container 2200.

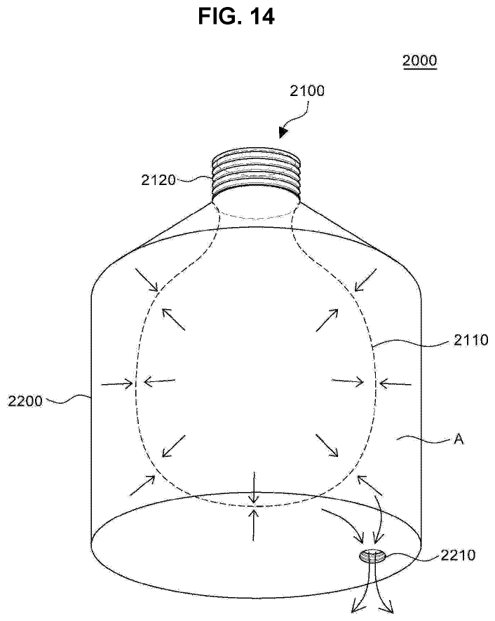

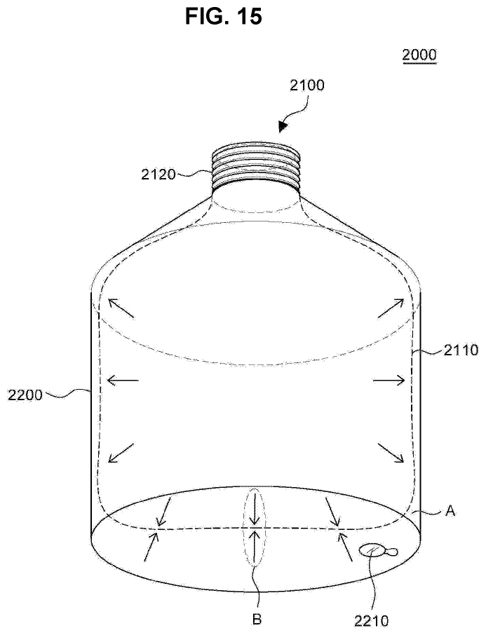

FIG. 14 is a view illustrating a process of manufacturing the container device 2000 according to an embodiment of the present disclosure, and FIG. 15 is a view illustrating the fully assembled container device 2000 according to an embodiment of the present disclosure.

As illustrated in FIG. 14, the elastic flexible pouch 2110 can have a volume smaller than the volume of the rigid container 2200, such that it can be inflated when content is injected into the elastic flexible pouch 2110. When the elastic flexible pouch 2110 is inflated, a restoring force for restoring its shape to its original shape like a balloon is generated by an elastic force. The restoring force not only keeps the volume of the elastic flexible pouch 2110 to accommodate the amount of the residual content so as to minimize the amount of content stuck to the internal wall of the elastic flexible pouch 2110, but also applies pressure to the flexible pouch 2110 such that the content in the elastic flexible pouch 2110 easily moves to the discharging portion 2120.

Therefore, it is preferable to implement the volume of the elastic flexible pouch 2110 before being inflated to expand by the content to be smaller than the volume of the rigid container 2200. However, meanwhile, when the content is filled in the elastic flexible pouch 2110, the elastic flexible pouch 2110 should be expanded to fit to a shape of the rigid container 2200 so that a sufficient amount of content can be filled into the volume of the rigid container 2200.

In this regard, when the elastic flexible pouch 2110 is inflated, the filling pressure of the content can be increased so that the elastic flexible pouch 2110 is inflated, but for this purpose, a filling nozzle and the discharging portion 2120 should be air-tightly coupled in order to prevent the content from flowing out between the filling nozzle for filling the content into the elastic flexible pouch 2110 and the discharging portion 2120. In addition, there is a problem that, when the filling of content is complete and the filling nozzle is disengaged from the discharging portion 2120, the content can flow back to the discharging portion 2120 by the restoring force of the elastic flexible pouch 2110, which additionally require a structure for preventing the backflow.

However, according to a typical filling method, the content is merely sprayed above the container device 2000 at which the filling nozzle is vertically installed, and the filling nozzle and the discharging portion 2120 of the container device 2000 are not air-tightly sealed and coupled. In such case, the filling time gets longer, and unnecessary cost may be incurred from an additional structure to prevent the backflow.

Therefore, after the content discharging device 2100 is coupled with the rigid container 2200 and the elastic flexible pouch 2110 is inserted into the rigid container 2200, the air is discharged, which is present in space A generated by a gap between the volume of the container device 2000 and the volume of the elastic flexible pouch 2110 before its inflation, through the air discharging port 2210. At this time, it is important to block alternative passages so that the air present in space A may be discharged outside of the rigid container 2200 only through the air discharging port 2210 by coupling the rigid container 2200 and the discharging portion 2120.

As illustrated in FIG. 15, when the air present in space A is removed through the air discharging port 2210, the elastic flexible pouch 2110 is expanded in volume to conform to the shape of the rigid container 2200 by a pressure difference B. Then, when the air discharging port 2210 is closed, the passage of air to and from space A is prohibited, such that the volume of the elastic flexible pouch 2110 can be kept to conform to the shape of the rigid container 2200, which allows filling the content in the conventional manner without adding an extra device to the container device 2000 or adding additional procedures thereto.

Meanwhile, the air discharging port 2210 may be installed with an air blocking portion, which is configured so that the air in the space between the internal wall of the container and the elastic flexible pouch is discharged externally, and also, capable of suppressing the flow of the air through the air discharging port 2210, and which suppresses the elastic flexible pouch, in which the outside air has flown into the space between the internal wall of the container and the elastic flexible pouch to be inflated, from being contracted.

At this time, the air blocking portion may be a valve means configured so that the air flows only in one direction from the inside of the container toward the outside of the container. One side of the air blocking portion contacts the inside of the container and the other side of the air blocking portion contacts the atmosphere.

At this time, when the volume of the elastic flexible pouch is expanded by applying pressure to the elastic flexible pouch due to the inflow of liquid or gas, the volume of the space between the elastic flexible pouch and the rigid container is reduced by an increase in the volume of the elastic flexible pouch, such that the air present in the space can be discharged to the outside of the rigid container through the air discharging port, thereby achieving the decompression of the space.

When a part of the air blocking portion covers the air discharging port and the decompression between the elastic flexible pouch and the rigid container is achieved, it is possible to suppress the air from being received from the outside of the rigid container through the air discharging port, thereby keeping the expanded state of the elastic flexible pouch in order to be filled in the elastic flexible pouch when the content is received through the opening of the elastic flexible pouch.

At this time, when the air discharging port is sealed by the air blocking portion, the pressure of the internal space of the elastic flexible pouch is applied smaller than the restoring force of the elastic flexible pouch.

A force acting on the inner surface of the elastic flexible pouch by the pressure of the internal space of the elastic flexible pouch and a force acting on the outer surface of the elastic flexible pouch by the pressure of the space between the elastic flexible pouch and the rigid container can be in equilibrium with the restoring force of the elastic flexible pouch.

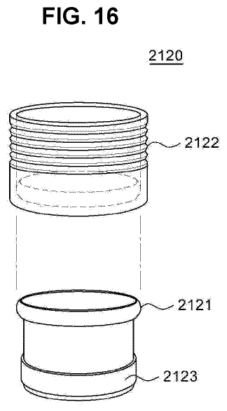

FIG. 16 is a view illustrating the discharging portion 2120 before it is assembled according to an embodiment of the present disclosure. The elastic flexible pouch 2110 is coupled to a container coupling portion 2121, which is the lower portion of the discharging portion 2120, and the content discharging device 2100 is coupled to the opening of the rigid container 2200 while the elastic flexible pouch 2110 is disposed in the rigid container 2200. Therefore, when the content injected through the opening of the rigid container 2200 flow into the elastic flexible pouch 2110. Thus, the discharging portion 2120 provides a passage to inject the content into the elastic flexible pouch 2110 or to discharge the content contained in the elastic flexible pouch 2110. The discharging portion 2120 may include the container coupling portion 2121 that is directly coupled with the elastic flexible pouch 2110 to be coupled with the rigid container 2200, and an upper cap 2122 that is coupled with the container coupling portion 2121 to fix the elastic flexible pouch 2110 and to couple with the discharger such as a pump. The container coupling portion 2121 may additionally include an air blocking band 2123 in order to completely block a passage of passing through the air when coupled with the rigid container 2200.

Any material, such as silicone or rubber, can be used as the air blocking band 2123 as long as it is capable of tightly coupling the container coupling portion 2121 to the internal wall or the outer wall of the opening of the rigid container 2200.

Both the container coupling portion 2121 of the discharging portion 2120 and the opening of the rigid container 2200 may have threads, respectively, to allow thread coupling, or the container coupling portion 2121 and the rigid container 2200 may have male and female protrusions, respectively, to allow fitting of the container coupling portion 2121 into the opening of the rigid container 2200.

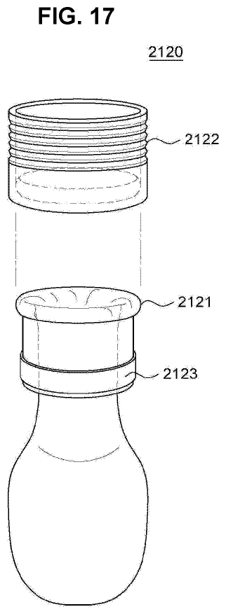

FIG. 17 is a view illustrating the discharging portion 2120 according to an embodiment of the present disclosure is coupled with the elastic flexible pouch 2110.

As illustrated in FIG. 17, the elastic flexible pouch 2110 is hooked by a hook provided at the upper end of the container coupling portion 2121, thereby coupling the elastic flexible pouch 2110 and the container coupling portion 2121. The discharger can be coupled with the thread formed on the upper cap 2122.

Meanwhile, although the elastic flexible pouch 2110 is implemented to be coupled to the container coupling portion 2121 rather than the rigid container 2200 in the above embodiment, the elastic flexible pouch 2110 may be directly coupled to the opening of the rigid container 2200 in another embodiment, and in this case, the elastic flexible pouch 2110 may be directly coupled to the discharger.

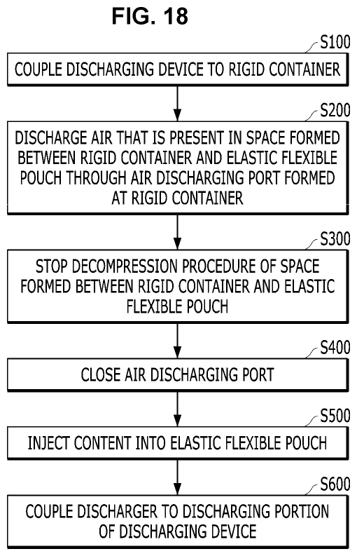

FIG. 18 is a view illustrating a process of manufacturing the container device 2000 according to an embodiment of the present disclosure.

At step S100, the content discharging device 2100 is coupled to the rigid container 2200.

At step S200, the air in space A formed between the rigid container 2200 and the elastic flexible pouch 2110 is discharged through the air discharging port 2210 formed in the rigid container 2200, thereby lowering a pressure of space A formed between the rigid container 2200 and the elastic flexible pouch 2110. The decompression process of lowering the pressure may be performed using a vacuum pump, etc., and at this time, in the decompression, it is possible to set and program the vacuum pump in advance in order to remove the air in space A formed between the rigid container 2200 and the elastic flexible pouch 2110 by a predetermined amount in consideration of the volume of the rigid container 2200, the material and thickness of the elastic flexible pouch 2110, etc.

When the pressure of space A formed between the rigid container 2200 and the elastic flexible pouch 2110 is sufficiently lowered and the volume of the elastic flexible pouch 2110 is sufficiently expanded in the rigid container 2200, the decompression procedure of lowering the pressure of space A formed between the rigid container 2200 and the elastic flexible pouch 2110 is terminated S300, and the air discharging port 2210 is closed S400.

When the air discharging port 2210 is closed, the elastic flexible pouch 2110 is expanded and kept in a state where its inside is empty in conformity with the rigid container 2200, such that, at the time of filling the content in the container device 2000, the content is filled in the expanded elastic flexible pouch 2110 S500.

The container device 2000 is filled with the content while the elastic flexible pouch 2110 is sufficiently expanded by the pressure difference therebetween, and then the discharger is coupled to the discharging portion 2120 of the content discharging device 2100 S600. The discharger performs a function of discharging the content in the elastic flexible pouch 2110, and may be implemented in various manners such as a pump type, a nozzle type, and a cap type according to the application of the product, etc.

[Adjustment of a Content Discharging Speed Using a Restoring Force]

The elastic flexible pouch 2110 has a restoring force to return back to its original state again as the content is filled and the volume thereof expands. Such a restoring force can easily discharge the content in the elastic flexible pouch 2110 even without using a pump, etc. At this time, it is possible to adjust the speed and the amount of discharging the content based on the size of the elastic flexible pouch 2110, the thickness of the elastic flexible pouch 2110, and the shape of the elastic flexible pouch 2110.

As describe above, although the embodiments of the present disclosure have been described in more detail with reference to the accompanying drawings, the present disclosure is not necessarily limited to those embodiments, and various modifications can be made without departing from the technical spirit of the present disclosure. Therefore, the embodiments disclosed in the present disclosure are intended to illustrate rather than limit the technical spirit of the present disclosure, and the scope of the technical spirit of the present disclosure is not limited by these embodiments. Therefore, it should be understood that the above-described embodiments are illustrative in all aspects and not restrictive. The scope of the present disclosure should be construed according to the appended claims, and all technical spirits within the scope equivalent thereto should be construed as included within the claims of the present disclosure.

Embodiments of the disclosure have been described in the above best mode for embodying the disclosure.

### INDUSTRIAL APPLICABILITY

An embodiment according to the present disclosure relates to the container device capable of storing and discharging the liquid, and is applicable to various containers capable of storing and discharging the liquid content, and is industrially applicable with its repetitive possibility.

1. A device for storing and discharging liquid, comprising:
a flexible pouch having an opening at one side thereof;
a fixing ring coupled to the opening; and
a discharging portion coupled to the fixing ring and capable of conveying content,
wherein the flexible pouch is inserted into a rigid container with a shape, and the discharging portion is coupled to the opening of the rigid container.

2. The device for storing and discharging liquid of claim 1,
wherein a shape of the flexible pouch is determined in advance in order to inflate to fit to the shape of the container when the content is filled therein.

3. The device for storing and discharging liquid of claim 1,
wherein the discharging portion further comprises a discharging tube.

4. The device for storing and discharging liquid of claim 3,
wherein the discharging portion and the discharging tube are manufactured simultaneously with a same material.

5. The device for storing and discharging liquid of claim 1,
wherein the fixing ring and the discharging portion are formed as separate components.

6. The device for storing and discharging liquid of claim 5, further comprising a water-proof ring interposed between the fixing ring and the discharging portion to prevent leakage of the content.

7. A device for storing and discharging liquid, comprising:
an elastic flexible pouch having an opening at one side thereof;
a fixing ring coupled to the opening; and
a discharging portion coupled to the fixing ring and capable of conveying content,
wherein the elastic flexible pouch is inserted into a rigid container with a shape, and the discharging portion is coupled to the opening of the rigid container.

8. The device for storing and discharging liquid of claim 7,
wherein the discharging portion comprises a backflow prevention portion.

9. The device for storing and discharging liquid of claim 7,
wherein a shape of the elastic flexible pouch is determined in advance in order to inflate to fit to the shape of the container when the content is filled therein.

10. The device for storing and discharging liquid of claim 7,
wherein the discharging portion further comprises a discharging tube.

11. The device for storing and discharging liquid of claim 10,
wherein the discharging portion and the discharging tube are manufactured simultaneously with a same material.

12. The device for storing and discharging liquid of claim 7,
wherein the fixing ring and the discharging portion are formed as separate components.

13. The device for storing and discharging liquid of claim 12, further comprising a water-proof ring interposed between the fixing ring and the discharging portion to prevent leakage of the content.

14. A device for storing and discharging liquid, comprising:
a flexible pouch having an opening at one side thereof; and
a discharging portion coupled to the opening and capable of conveying the content of the flexible pouch,
wherein the flexible pouch is inflated in a shape of the container according to the inflation of the volume thereof when it is inserted into a rigid container with a shape and the content is injected into the flexible pouch, and the discharging portion is coupled to the opening of the rigid container.

15. The device for storing and discharging liquid of claim 14,
wherein the discharging portion further comprises a discharging tube.

16. The device for storing and discharging liquid of claim 15,
wherein the discharging portion and the discharging tube have been manufactured simultaneously as the same material.

17. A device for storing and discharging liquid, comprising:
an elastic flexible pouch having an opening at one side thereof; and
a discharging portion coupled to the opening and capable of conveying the content of the elastic flexible pouch,
wherein the elastic flexible pouch is inflated in a shape of the container according to the inflation of the volume thereof when it is inserted into a rigid container with a shape and the content is injected into the elastic flexible pouch, and the discharging portion is coupled to the opening of the rigid container.

18. The device for storing and discharging liquid of claim 17,
wherein the discharging portion further comprises a discharging tube.

19. The device for storing and discharging liquid of claim 18,
wherein the discharging portion and the discharging tube are manufactured simultaneously with a same material.

20. The device for storing and discharging liquid of claim 19,
wherein the discharging portion comprises a backflow prevention portion.

21-31. (canceled)
